(19) United States
(12) Patent Application Publication
(10) Pub. No.: US 2017/0077987 A1
(43) Pub. Date: Mar. 16, 2017

(54) MIXER CIRCUIT AND WIRELESS COMMUNICATION DEVICE

(71) Applicant: KABUSHIKI KAISHA TOSHIBA, Tokyo (JP)

(72) Inventor: Toshiya MITOMO, Yokohama Kanagawa (JP)

(21) Appl. No.: 15/232,545

(22) Filed: Aug. 9, 2016

(30) Foreign Application Priority Data
Sep. 15, 2015 (JP) 2015-181900

(51) Int. Cl. H04B 1/525; H04B 1/3827; H01Q 1/48

(52) U.S. Cl. CPC H04B 1/525; H01Q 1/48; H04B 1/3833

(57) ABSTRACT

A mixer circuit includes a voltage-current conversion circuit configured to convert a positive-phase voltage signal and a negative-phase voltage signal to a positive-phase current signal and a negative-phase current signal, respectively, a switching circuit having a first terminal for receiving the positive-phase current signal and a second terminal for receiving the negative-phase current signal, and configured to output a positive-phase output signal by switching between the positive-phase current signal and the negative-phase current signal, and a negative-phase output signal by switching between the negative-phase current signal and the positive-phase current signal, a first wiring connecting the first terminal to the voltage-current conversion circuit, a second wiring connecting the second terminal to the voltage-current conversion circuit, and a capacitor connected between the first terminal and the second terminal.

### CROSS-REFERENCE TO RELATED APPLICATION

This application is based upon and claims the benefit of priority from Japanese Patent Application No. 2015-181900, filed on Sep. 15, 2015, the entire contents of which are incorporated herein by reference.

### FIELD

Embodiments described herein relate generally to a mixer circuit and a wireless communication device having the same.

### BACKGROUND

In general, a mixer circuit is used for frequency conversion, quadrature modulation, or the like. A mixer circuit may be of a double balance type, which operates on a differential input signal.

However, leakage of a local signal, so-called carrier leakage, may be generated depending on the configuration thereof. As a result, communication quality of a wireless communication device having such a mixer circuit may decrease.

### DESCRIPTION OF THE DRAWINGS

FIG. 1 is a block diagram illustrating a transmission unit of a wireless communication device according to an embodiment.

FIG. 2 is a circuit diagram of a mixer unit of the transmission unit according to the embodiment.

FIG. 3 is a circuit diagram of a double balance type mixer circuit in the mixer unit according to the embodiment.

FIG. 4 illustrates a potential difference between common terminals according to the embodiment and the one according to a comparative example.

### DETAILED DESCRIPTION

An embodiment provides a mixer circuit which reduces carrier leakage.

In general, according to an embodiment, a mixer circuit includes a voltage-current conversion circuit configured to convert a positive-phase voltage signal and a negative-phase voltage signal to a positive-phase current signal and a negative-phase current signal, respectively, a switching circuit having a first terminal for receiving the positive-phase current signal and a second terminal for receiving the negative-phase current signal, and configured to output a positive-phase output signal by switching between the positive-phase current signal and the negative-phase current signal, and a negative-phase output signal by switching between the negative-phase current signal and the positive-phase current signal, a first wiring connecting the first terminal to the voltage-current conversion circuit, a second wiring connecting the second terminal to the voltage-current conversion circuit, and a capacitor that is connected between the first terminal and the second terminal.

Hereinafter, an embodiment is described with reference to the drawings.

### First Embodiment

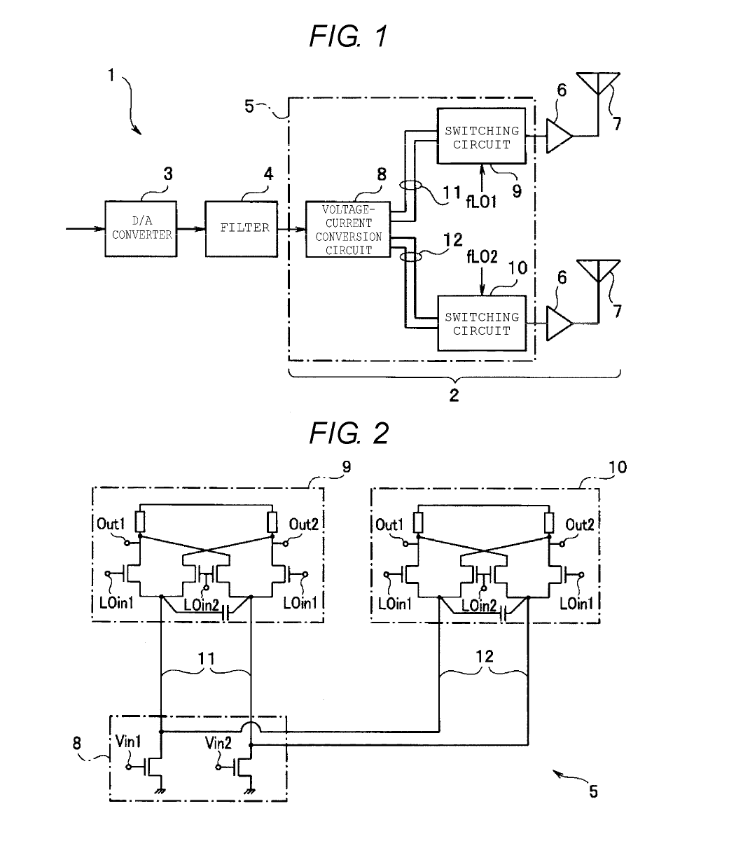

FIG. 1 is a block diagram illustrating a configuration of a transmission unit of a wireless communication device 1 according to an embodiment. The wireless communication device 1 is, for example, a smart phone or a tablet terminal, and includes a signal transmission unit 2. The signal transmission unit 2 can perform data transmission in multiple (here, two) frequency bands.

A digital signal of transmission data is input to a digital-to-analog conversion circuit (hereinafter, referred to as D/A converter) 3 and is converted into an analog signal. An analog signal which is output from the D/A converter 3 is supplied to the signal transmission unit 2 through a filter 4 that is a low pass filter or an anti-aliasing filter.

The signal transmission unit 2 includes a mixer unit 5 which is a frequency converter, two amplifiers 6, and two antennas 7. The mixer unit 5 is a double balance type mixer circuit (Gilbert mixer circuit) which includes a voltage-current conversion circuit 8 and two switching circuits 9 and 10. That is, here, in order to perform multiple (here, two) band transmissions, multiple (here, two) switching circuits 9 and 10 are connected to one voltage-current conversion circuit 8.

The switching circuit 9 receives a local signal of a predetermined first frequency fLO1, and the switching circuit 10 receives a local signal of a predetermined second frequency fLO2. The local signals of the two frequencies fLO1 and fLO2 are generated by a local oscillator (not illustrated).

The wireless communication device 1 wirelessly transmits a data signal from a corresponding antenna 7 by operating the switching circuit 9 or 10 corresponding to a frequency which is selected to be used at the time of transmitting data.

A wireless signal of a high frequency of, for example, 2.4 GHz is output from the antenna 7 connected to the switching circuit 9, and a wireless signal of a high frequency of, for example, 5 GHz is output from the antenna 7 connected to the switching circuit 10.

FIG. 2 is a circuit diagram of the mixer unit 5.

The voltage-current conversion circuit 8 of the mixer unit 5 includes input terminals Vin1 and Vin2 to which differential input voltage signals of a low frequency are input. A transmission signal from the filter 4 is input to the voltage-current conversion circuit 8 from the input terminals Vin1 and Vin2 as a differential input voltage signal.

The voltage-current conversion circuit 8 and the switching circuit 9 are electrically connected to each other by wiring, that is, a wiring pattern 11 on a semiconductor substrate. The voltage-current conversion circuit 8 and the switching circuit 10 are electrically connected to each other by wiring, that is, a wiring pattern 12 on a semiconductor substrate.

That is, the voltage-current conversion circuit 8, the switching circuits 9 and 10, the wiring patterns 11 and 12, and a capacitor which are described below are formed on a semiconductor device.

Each of the wiring patterns 11 and 12 includes two patterns of wiring for a positive phase current signal and wiring for a negative phase current signal.

For example, lengths of two wiring patterns of the wiring pattern 11 or 12 can be lengthened on a semiconductor chip on which the mixer unit 5 is mounted.

The lengths of the wirings which are lengthened cause asymmetry between a positive phase current signal and a negative phase current signal, and deteriorate communication quality.

Hence, in a double balance type mixer circuit according to the embodiment, a capacitor is connected between respective common terminals, and asymmetry between the positive phase current signal and the negative phase current signal is reduced.

Next, a double balance type mixer circuit according to the present embodiment is described in detail.

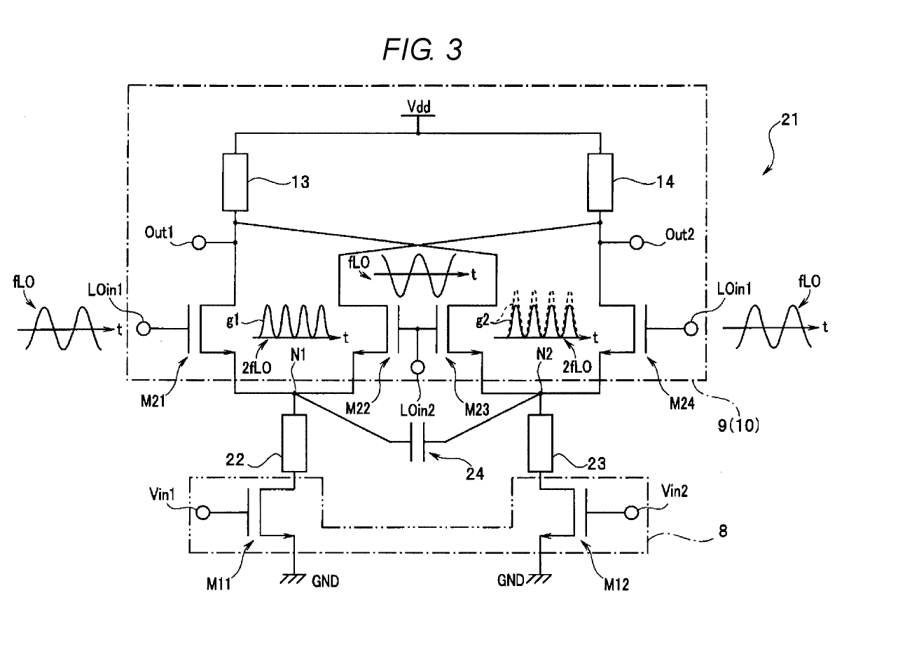

FIG. 3 is a circuit diagram of a mixer circuit 21 of a double balance type according to the present embodiment.

The double balance type mixer circuit (hereinafter, also simply referred to as mixer circuit) 21 of FIG. 3 represents only one of the switching circuits 9 and 10, the voltage-current conversion circuit 8, and the switching circuit 9 (or 10). A differential input voltage signal of a predetermined frequency is input to the voltage-current conversion circuit 8, and a differential local signal of a higher frequency fLO1 (or fLO2, hereinafter the frequency fLO1 or fLO2 is referred to as frequency fLO) than a frequency of the differential input voltage signal is input to the switching circuit 9 (or 10).

As illustrated in FIG. 3, the positive phase input voltage signal and the negative phase input voltage signal which are differential input voltage signals of a frequency fBB that functions as baseband signals are respectively input to the first and second input terminals Vin1 and Vin2 of the voltage-current conversion circuit 8.

Meanwhile, a positive phase local signal and a negative phase local signal which are differential local signals of a high frequency of a frequency fLO are respectively input to first and second local terminals LOin1 and LOin2 of the switching circuit 9 or 10.

The mixer circuit 21 performs multiplication of the differential input voltage signal and the differential local signal. The mixer circuit 21 outputs a positive phase output signal and a negative phase output signal which correspond to the multiplication results from output terminals Out1 and Out2. The positive phase output signal and the negative phase output signal are supplied to the amplifier 6.

Load circuits 13 and 14 are respectively connected between output terminals Out1 and Out2 and a power supply voltage Vdd. The load circuits 13 and 14 are resistor elements or transistors, for example.

The voltage-current conversion circuit 8 includes two transistors M11 and M12 which are MOS transistors. Gate terminals of the transistors M11 and M12 are respectively connected the input terminals Vin1 and Vin2. A common source terminal of the transistors M11 and M12 is connected to a ground GND.

The common source terminal may be connected to the ground GND through a current source.

Drain terminals of the transistors M11 and M12 are respectively connected to common terminals N1 and N2 through wiring patterns 22 and 23.

The positive phase input voltage signal and the negative phase input voltage signal from the input terminals Vin1 and Vin2 are converted into differential current signals, that is, a positive phase current signal and a negative phase current signal by the voltage-current conversion circuit 8 at an input stage. The positive phase current signal and the negative phase current signal from the voltage-current conversion circuit 8 are respectively supplied to the two common terminals N1 and N2 of the switching circuit 9 (or 10).

Hence, the voltage-current conversion circuit 8 converts the positive phase input voltage signal and the negative phase input voltage signal which are respectively input to the first input terminal Vin1 and the second input terminal Vin2 into a positive phase current signal and a negative phase current signal.

The switching circuit 9 (or 10) includes two sets of differential pairs which include transistors M21, M22, M23, and M24 that are MOS transistors. A common source terminal of the transistors M21 and M22, and a common source terminal of the transistors M23 and M24 are respectively connected to the common terminals N1 and N2.

Two gate terminals of the transistors M21 and M24 are connected to the first local terminal LOin1. Two gate terminals of the transistors M22 and M23 are connected to the second local terminal LOin2.

Two drain terminals of the transistors M21 and M23 are connected to the load circuit 13, and are connected to the output terminal Out1. Two drain terminals of the transistors M22 and M24 are connected to the load circuit 14, and are connected to the output terminal Out2.

In the switching circuit 9 (or 10), the positive phase current signal and the negative phase current signal from the voltage-current conversion circuit 8 are switched in accordance with the positive phase local signal and the negative phase local signal from the local terminals LOin1 and LOin2, whereby a differential output current signal, that is, the positive phase output signal and the negative phase output signal are generated.

The positive phase output signal and the negative phase output signal which are generated are output from the output terminals Out1 and Out2 as differential output signals, that is, a positive phase output signal and a negative phase output signal, after being converted into voltage signals by the load circuits 13 and 14, or in the form of signals as they are.

Hence, the switching circuits 9 and 10 include the first common terminal N1 and the second common terminal N2 which respectively receive the positive phase current signal and the negative phase current signal, and the first local terminal LOin1 and the second local terminal LOin2 which respectively receive the positive phase local signal and the negative phase local signal. The switching circuits 9 and 10 generate the positive phase output signal and the negative phase output signal by switching the positive phase current signal and the negative phase current signal in accordance with the positive phase local signal and the negative phase local signal.

In FIG. 3, the switching circuit 9 (or 10) includes MOS transistors, but may include a bipolar transistor or other elements.

The mixer circuit 21 of a double balance type is formed on a semiconductor chip, and the voltage-current conversion circuit 8 and the switching circuit 9 (or 10) are electrically connected to each other by wiring patterns 22 and 23. The wiring pattern 22 is wiring between a drain terminal of the transistor M11 and the common terminal N1. The wiring pattern 23 is wiring between a drain terminal of the transistor M12 and the common terminal N2. The wiring patterns 22 and 23 are denoted by rectangular blocks in FIG. 3.

That is, the wiring patterns 22 and 23 configure first and second wirings which respectively connect the common terminal N1 to the voltage-current conversion circuit 8, and the common terminal N2 to the voltage-current conversion circuit 8.

If wiring lengths of the wiring patterns 22 and 23 are lengthened, a difference of wiring characteristics between the two wiring patterns 22 and 23, that is, impedance difference occurs in the common terminals N1 and N2.

That is, there is impedance difference between the wiring patterns 22 and 23. If there is impedance difference, asymmetry between the positive phase current signal and the negative phase current signal occurs, as a result.

Focusing on the common terminal N1, the frequency of the local signal is fLO, and the transistor M21 is switched in accordance with a positive phase local signal which is input to the local terminal LOin1, and the transistor M22 is also switched in accordance with a negative phase local signal which is input to the local terminal LOin2. A potential of the common terminal N1 is changed in accordance with the switching of the transistors M21 and M22.

In the same manner, a potential of the common terminal N2 is changed in accordance with the switching of the transistors M23 and M24.

In FIG. 3, the potential of the common terminal N1 is changed by a frequency 2fLO which is twice the frequency fLO of the local signal which is input to the local terminals LOin1 and LOin2, as illustrated in a graph g1. In the same manner, a potential of the common terminal N2 is changed by a frequency 2fLO which is twice the frequency fLO, as illustrated in a graph g2.

Here, if there is a difference of wiring characteristics between the wiring patterns 22 and 23, the potential of the common terminal N1 and the potential of the common terminal N2 are changed in the same manner as denoted by solid lines of graphs g1 and g2. If the potential of the common terminal N1 and the potential of the common terminal N2 are changed in the same manner as denoted by solid lines of graphs g1 and g2, it is possible to remove same phase components such as noise by performing subtraction of an output signal of the output terminal Out1 and an output signal of the output terminal Out2 at a circuit of a rear stage.

However, if there is a difference in wiring characteristics between the wiring patterns 22 and 23, a potential difference occurs between the potential of the common terminal N1 and the potential of the common terminal N2. In FIG. 3, the potential of the common terminal N2 is higher than the potential of the common terminal N1, as denoted by a dotted line of the graph g2.

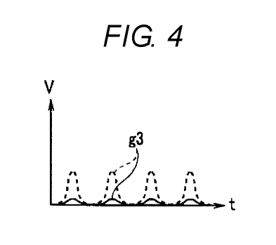

If the potential of the common terminal N1 is different from the potential of the common terminal N2, two signals which have the same phase and the frequency 2fLO which is twice the frequency fLO include differential components, in the common terminals N1 and N2, as denoted by a dotted line of a graph g3 of FIG. 4 which is described below, whereby carrier leakage occurs. For example, a local signal of 5 GHz is subtracted from a local signal with differential components of 10 GHz, whereby carrier leakage of a signal of 5 GHz occurs.

That is, a local signal of 5 GHz which is applied to each gate of the transistors M21 to M24 and a signal of 10 GHz of a source are multiplied by asymmetry between respective transistors, whereby a signal of 5 GHz is generated as the difference. At this time, the signal of 10 GHz between the common terminals N1 and N2 includes differential components, and thus the signal of 5 GHz is output as an output of the mixer unit 5, and the signal becomes carrier leakage.

Hence, in the mixer circuit 21 according to the embodiment, a capacitor 24 is provided to connect the common terminal N1 to the common terminal N2, as a filter element through which the signal of the frequency fLO of the local signal passes, as illustrated in FIG. 3.

The capacitor 24 has a capacitance value in which impedance becomes extremely small to a signal of the frequency 2fLO which is twice that of the local signal, and the impedance becomes extremely large to a differential input voltage signal which is the baseband signal. In other words, the capacitor 24 connected between the common terminals N1 and N2 has a capacitance value in which impedance is small in a frequency band which is twice that of the local signal such that the common terminals N1 and N2 become the same potential or approximately the same potential while the signal of the frequency 2fLO which is twice that of the local signal flows, and the impedance is large to a baseband signal.

For example, if the frequency fBB of the baseband signal is several hundred MHz or lower and the frequency fLO of the local signal is several GHz, the capacitance of the capacitor 24 has a small impedance value such that a signal of a frequency which is twice that of the local signal flows, and has a large impedance value, which is higher than the impedance value to the local signal by 10 times or more, to the baseband signal such that the signal at the baseband frequency does not flow.

That is, the capacitor 24 has a smaller impedance than that of a signal with a frequency band which is the same as that of the positive phase input voltage signal and the negative phase input voltage signal, a signal with a frequency band which is the same as that of the positive phase local signal and the negative phase local signal.

Here, impedance to the positive phase current signal and the negative phase current signal of the capacitor 24 is greater than input impedance of the switching circuits 9 and 10 to the positive phase current signal and the negative phase current signal.

For example, the impedance of the capacitor 24 to the input signal is sufficiently greater than the input impedances of the switching transistors M21 to M24 to the input signal, for example, 10 times or greater, and an input signal current does not flow into the capacitor 24 and is input to the switching transistors M21 to M24.

In addition to above description, impedance to the positive phase local signal and the negative phase local signal of the capacitor 24 is smaller than impedance to the positive phase local signal and the negative phase local signal of the voltage-current conversion circuit 8.

For example, the impedance of the capacitor 24 to the local signal (signal having a frequency which is twice that of the local signal) is sufficiently smaller than the input impedances of the voltage-current conversion circuit 8 with respect to the local signal, for example, 1/10 times or smaller, and a signal of a frequency twice that of the local signal is reduced by the capacitor 24.

FIG. 4 is a graph illustrating a potential difference between the common terminals N1 and N2. In FIG. 4, the graph g3 denoted by a dotted line represents a change of the potential difference between the common terminals N1 and N2 depending on time t, when the common terminals N1 and N2 are not connected to each other by the capacitor 24. In FIG. 4, the graph g3 denoted by a solid line represents the change of the potential difference between the common terminals N1 and N2 depending on the time elapse t, when the common terminals N1 and N2 are connected to each other by the capacitor 24.

As the capacitor 24 described above is provided to connect the common terminal N1 to the common terminal N2, a potential difference, which relates to a signal of a frequency twice that of the local signal, between the common terminals N1 and N2 is remarkably small, as denoted by the solid line of the graph g3 of FIG. 4, and thus carrier leakage is reduced. Furthermore, degradation of amplitude of a baseband signal with a lower frequency than that of the local signal is also reduced, and thus there is also no degradation of gain or the like.

As described above, according to the present embodiment, it is possible to provide a mixer circuit which reduces carrier leakage.

Impedance difference between two wiring patterns can be reduced by wiring layout of wiring patterns on a semiconductor device. However, in order to reduce impedance difference, a wiring pattern area can be widened. Furthermore, much time is taken not only for wiring layout of wiring patterns for matching wiring characteristics of wiring patterns, but also for verification thereof.

However, according to the present embodiment, it is possible to simply reduce carrier leakage simply by connecting the common terminal N1 to the common terminal N2 using the capacitor 24.

The double balance type mixer circuit according to the present embodiment can also be applied to quadrature modulator or the like in addition to the above-described frequency modulator, and can be used for various wireless communication devices.

When being applied to a quadrature modulator, the double balance type mixer circuit according to the present embodiment can also be applied to a quadrature modulation transmitter including a D/A converter which processes quadrature signals of two channels, a filter, a voltage-current converter, switching circuits of two channels which process quadrature local signals, and an adder which adds signals output from each quadrature switching circuit together.

The double balance type mixer circuit includes a voltage-current conversion circuit and a switching circuit. According to the double balance type mixer circuit, it is possible to generate a differential output signal of a high frequency including a low frequency by switching a differential current signal according to a differential input voltage signal of a low frequency using a differential local signal in a switching circuit.

However, if a double balance type mixer circuit is formed on a semiconductor device, a voltage-current conversion circuit cannot be arranged near a switching circuit, and physical lengths of two wirings between the voltage-current conversion circuit and the switching circuit, that is, physical lengths of wiring for a positive phase current signal and wiring for a negative phase current signal can be lengthened.

In addition, if two switching circuits are connected to one voltage-current conversion circuit and a switching circuit is selectively used in accordance with a transmission frequency, in order to perform transmission of multiple, for example, two bands which uses frequency bands different from each other, physical lengths of two wirings on a semiconductor device between each switching circuit and a voltage-current conversion circuit can be lengthened.

There is a problem that, if wiring for the positive phase current signal and wiring for negative phase current signal are lengthened, a difference of wiring characteristics between two wirings occurs, and asymmetry between a positive phase current signal and a negative phase current signal occurs.

The asymmetry between the positive phase current signal and the negative phase current signal causes leakage of a local signal, so-called carrier leakage, and as a result, communication quality decreases.

In contrast to this, according to the present embodiment described above, it is possible to provide a mixer circuit which reduces carrier leakage.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mixer circuit, comprising:
a voltage-current conversion circuit configured to convert a positive-phase voltage signal and a negative-phase voltage signal to a positive-phase current signal and a negative-phase current signal, respectively;
a switching circuit having a first terminal for receiving the positive-phase current signal and a second terminal for receiving the negative-phase current signal, and configured to output a positive-phase output signal by switching between the positive-phase current signal and the negative-phase current signal, and a negative-phase output signal by switching between the negative-phase current signal and the positive-phase current signal;
a first wiring connecting the first terminal to the voltage-current conversion circuit;
a second wiring connecting the second terminal to the voltage-current conversion circuit; and
a capacitor connected between the first terminal and the second terminal.

2. The mixer circuit according to claim 1, wherein the switching circuit outputs the positive-phase current signal as the positive-phase output signal when outputting the negative-phase current signal as the negative-phase output signal, and outputs the negative-phase current signal as the positive-phase output signal when outputting the positive-phase current signal as the negative-phase output signal.

3. The mixer circuit according to claim 2, wherein
the switching circuit outputs the positive-phase current signal as the positive-phase output signal and the negative-phase current signal as the negative-phase output signal, based on a positive-phase local signal, and outputs the negative-phase current signal as the positive-phase output signal and the positive-phase current signal as the negative-phase output signal, based on a negative-phase local signal.

4. The mixer circuit according to claim 3, wherein
an impedance of the capacitor with respect to the positive-phase and negative-phase local signals is smaller than an impedance of the capacitor with respect to the positive-phase and negative-phase voltage signals.

5. The mixer circuit according to claim 1, wherein
the switching circuit includes a first pair of transistors connected to the first terminal and in parallel to each other and a second pair of transistors connected to the second terminal and in parallel to each other, and
an impedance of the capacitor with respect to the positive-phase and negative-phase current signals is greater than an impedance of each of the first pair of the transistors with respect to the positive-phase current signal and an impedance of each of the second pair of the transistors with respect to the negative-phase current signal.

6. The mixer circuit according to claim 1, wherein
the voltage-current conversion circuit includes a first transistor having a gate that receives the positive-phase voltage signal, a first end connected to the first terminal, and a second end connected to ground or DC current source, and a second transistor having a gate that receives the negative-phase voltage signal, a first end connected to the second terminal, and a second end connected to ground or DC current source.

7. The mixer circuit according to claim 1, wherein
an impedance of the first wiring is different from an impedance of the second wiring.

8. The mixer circuit according to claim 1, wherein
a length of the first wiring is different from a length of the second wiring.

9. The mixer circuit according to claim 1, further comprising:
a second switching circuit having a third terminal for receiving the positive-phase current signal and a fourth terminal for receiving the negative-phase current signal, and configured to output a second positive-phase output signal by switching between the positive-phase current signal and the negative-phase current signal, and a second negative-phase output signal by switching between the negative-phase current signal and the positive-phase current signal;
a third wiring connecting the third terminal to the voltage-current conversion circuit;
a fourth wiring connecting the fourth terminal to the voltage-current conversion circuit; and
a second capacitor connected between the third terminal and the fourth terminal.

10. The mixer circuit according to claim 9, wherein output frequencies of the switching circuits are different.

11. A wireless communication module, comprising an analog-to-digital converter, a filter, a mixer circuit, and an antenna connected in series in this order, wherein the mixer circuit includes:
a voltage-current conversion circuit configured to convert a positive-phase voltage signal and a negative-phase voltage signal to a positive-phase current signal and a negative-phase current signal, respectively;
a switching circuit having a first terminal for receiving the positive-phase current signal and a second terminal for receiving the negative-phase current signal, and configured to output a positive-phase output signal by switching between the positive-phase current signal and the negative-phase current signal, and a negative-phase output signal by switching between the negative-phase current signal and the positive-phase current signal;
a first wiring connecting the first terminal to the voltage-current conversion circuit;
a second wiring connecting the second terminal to the voltage-current conversion circuit; and
a capacitor connected between the first terminal and the second terminal.

12. The wireless communication module according to claim 11, wherein
the switching circuit outputs the positive-phase current signal as the positive-phase output signal when outputting the negative-phase current signal as the negative-phase output signal, and outputs the negative-phase current signal as the positive-phase output signal when outputting the positive-phase current signal as the negative-phase output signal.

13. The wireless communication module according to claim 12, wherein
the switching circuit outputs the positive-phase current signal as the positive-phase output signal and the negative-phase current signal as the negative-phase output signal, based on a positive-phase local signal, and outputs the negative-phase current signal as the positive-phase output signal and the positive-phase current signal as the negative-phase output signal, based on a negative-phase local signal.

14. The wireless communication module according to claim 13, wherein
an impedance of the capacitor with respect to the positive-phase and negative-phase local signals is smaller than an impedance of the capacitor with respect to the positive-phase and negative-phase voltage signals.

15. The wireless communication module according to claim 11, wherein
the switching circuit includes a first pair of transistors connected to the first terminal and in parallel to each other and a second pair of transistors connected to the second terminal and in parallel to each other, and
an impedance of the capacitor with respect to the positive-phase and negative-phase current signals is greater than an impedance of each of the first pair of the transistors with respect to the positive-phase current signal and an impedance of each of the second pair of the transistors with respect to the negative-phase current signal.

16. The wireless communication module according to claim 11, wherein
the voltage-current conversion circuit includes a first transistor having a gate that receives the positive-phase voltage signal, a first end connected to the first terminal, and a second end connected to ground or DC current source, and a second transistor having a gate that receives the negative-phase voltage signal, a first end connected to the second terminal, and a second end connected to ground or DC current source.

17. A mixer circuit, comprising:
a first pair of transistors that are connected in parallel and switched based on local signals;
a second pair of transistors that are connected in parallel and switched based on the local signals;
a first transistor that is connected to the first pair of switching elements in series and has a switching terminal that receives a positive-phase input;
a second transistor that is connected to the second pair of switching elements in series and has a switching terminal that receives a negative-phase input; and
a capacitor connected to a first node between the first transistor and the first pair of transistors and a second node between the second transistor and the second pair of transistors.

18. The mixer circuit according to claim 17, wherein
a potential difference between opposite sides of the capacitor is lower than the potential difference without the capacitor.

19. The mixer circuit according to claim 17, wherein
a leakage of the local signals into outputs of the mixer circuit with the capacitor is lesser than the leakage of the local signals into outputs of the mixer circuit without the capacitor.

20. The mixer circuit according to claim 17, wherein
a frequency of the local signals is ten times or more greater than a frequency of the positive-phase and negative-phase inputs.
